(19) United States
(12) Patent Application Publication
(10) Pub. No.: US 2020/0242325 A1
(43) Pub. Date: Jul. 30, 2020

(54) Biometric Device and Biometric Scanning Method Employing Two-Step Scan

(71) Applicant: InnoLux Corporation, Miao-Li County (TW)

(72) Inventor: Kazuyuki Hashimoto, Miao-Li County (TW)

(21) Appl. No.: 16/257,017

(22) Filed: Jan. 24, 2019

(51) Int. Cl. G06K 9/00

(52) U.S. Cl. CPC G06K 9/00026; G06K 9/00993

(57) ABSTRACT

A biometric device includes a panel having a detection area and a non-detection area adjacent to the detection area. The panel includes a driver circuit, a first logic circuit, a plurality of signal lines and a plurality of sensing units. At least a part of the driver circuit is located in the non-detection area. The first logic circuit is electrically connected to the driver circuit, and used to generate a plurality of control signals. At least a part of the plurality of signal lines is located in the detection area. The plurality of sensing units are located in the detection area and arranged along one direction. Each of the plurality of sensing units is respectively and electrically connected to the first logic circuit and a corresponding signal line in the plurality of signal lines. When each sensing unit in the plurality of sensing units receives one of the plurality of control signals, the plurality of sensing units are configured into a plurality of skip areas and a plurality of scan areas. The plurality of skip areas are disabled in a coarse scan process, and the plurality of scan areas are enabled to detect the fingerprint outline in the coarse scan process.

### BACKGROUND OF THE DISCLOSURE

### 1. Field of the Disclosure

The invention relates to biometric technology, and specifically, to a biometric device and a biometric scanning method employing a two-step scan.

### 2. Description of the Prior Art

The advancements in biometric technology, particularly in fingerprint recognition technology, have already established the technology itself as the means for secure identification and authentication, and have found a variety of applications in law enforcement, banking, voting, and other industries increasingly relying upon fingerprints as a biometric to verify identity.

A fingerprint scanner is often employed to capture and identify the fingerprints of an individual in order to grant or deny access to a computer system or a physical facility. The increasing requirements on tighter security raise the demand of high-resolution fingerprint scanners. For example, A 500 dpi resolution is now required. Nevertheless, the higher resolution is typically achieved by incorporating a very high number of sensing units and analog-to-digital converters (ADCs) in a fingerprint scanner. Such a design drives up the manufacturing costs and increases signal processing time.

Therefore, a need has arisen for a biometric device capable of speeding up signal processing without increasing manufacturing costs, and a biometric scanning method thereof.

### SUMMARY OF THE DISCLOSURE

In one aspect of the invention, a biometric device including a panel having a detection area and a non-detection area is disclosed. The non-detection area is adjacent to the detection area. The panel includes a driver circuit, a first logic circuit, a plurality of signal lines and a plurality of sensing units. At least a part of the driver circuit is located in the non-detection area. The logic circuit is electrically connected to the driver circuit, and used to generate a plurality of control signals. At least a part of the plurality of signal lines is located in the detection area. The plurality of sensing units are located in the detection area and arranged along one direction. Each of the plurality of sensing units is respectively and electrically connected to the first logic circuit and a corresponding signal line in the plurality of signal lines. When each sensing unit in the plurality of sensing units receives one of the plurality of control signals, the plurality of sensing units are configured into a plurality of skip areas and a plurality of scan areas. The plurality of skip areas are disabled in a coarse scan process, and the plurality of scan areas are enabled to detect the fingerprint outline in the coarse scan process.

In another aspect of the invention, a biometric scanning method performed by a biometric device is provided. The biometric device includes a detection area including a plurality of skip areas and a plurality of scan areas. The biometric scanning method includes: performing a coarse scan by enabling the plurality of scan areas and disabling the plurality of skip areas to detect a fingerprint outline; and performing a fine scan by enabling a part of the plurality of skip areas which is inside the fingerprint outline to generate a fingerprint image.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a block diagram of a biometric device according to one embodiment of the invention.

FIG. 2 is a schematic diagram of the sensing array in FIG. 1.

FIG. 3 shows a schematic diagram of a coarse scan process employing the biometric device in FIG. 1.

FIG. 4 shows a schematic diagram of a fine scan process employing the biometric device in FIG. 1.

FIG. 5 is a circuit schematic of a biometric device according to one embodiment of the invention.

FIG. 6 is a timing diagram of the biometric device in FIG. 5.

FIG. 7 is a circuit schematic of a biometric device according to another embodiment of the invention.

FIG. 8 is a circuit schematic of a biometric device according to yet another embodiment of the invention.

FIG. 9 is a flowchart of a fingerprint scanning method employing the biometric device in FIG. 5, FIG. 7, or FIG. 8.

### DETAILED DESCRIPTION

As used herein, the term “fingerprint” refers to the ridge and valley detail of a single fingerprint, a partial fingerprint, multiple fingerprints or any portion of a skin surface having surface ridges and valleys.

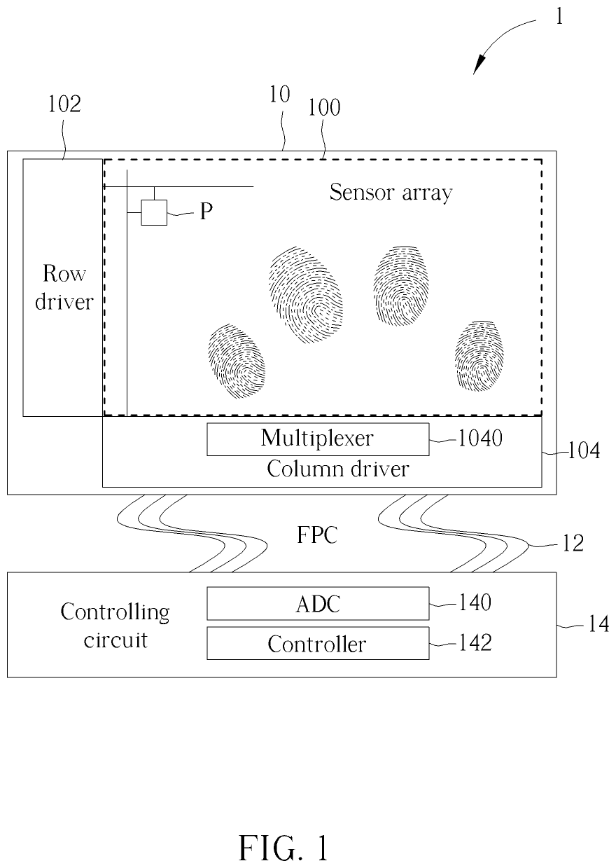

FIG. 1 is a block diagram of a biometric device 1 according to one embodiment of the invention. The biometric device 1 comprises a panel 10, a flexible printed circuit (FPC) 12 and a controlling circuit 14. The panel 10 has a detection area such as a region of sensing array 100 comprising a plurality of sensing units, and a non-detection area adjacent to the detection area, such as the region of a row driver 102 or the region of a column driver 104. The panel 10 is electrically connected to the controlling circuit 14 via the FPC 12. The panel 10 may detect a fingerprint of a finger positioned on the detection area, generate electrical signals representing the fingerprint, and transfer the electrical signals to the controlling circuit 14 for subsequent data processing and analyzing. In particular, the biometric device 1 may perform a two-step scan process including a coarse scan and then a fine scan. In the coarse scan, the biometric device 1 may scan a detection area of the panel 10 at intervals to detect a fingerprint outline of a fingerprint, and in the fine scan, the biometric device 1 may scan a fingerprint area inside the fingerprint outline to generate biometric data of the fingerprint, such as a fingerprint image. The panel 10 has the detection area where a fingerprint can be detected and the non-detection area where no fingerprint can be detected. In both the coarse scan and fine scan, only selected areas of the detection area on the panel 10 are configured to detect the fingerprint, and the other areas of the detection area on the panel 10 are configured to skip detection, thereby speeding up the scan process while not losing fingerprint information.

The panel 10 may have a touch screen function, and comprises a sensing array 100, the row driver 102 and the column driver 104. The sensing array 100 is respectively electrically connected to the row driver 102 and the column driver 104, and may be driven by the row driver 102 and the column driver 104 to scan a fingerprint in a raster order. The sensing array 100 may be an optical, capacitive, radio frequency (RF), thermal, piezoresistive, ultrasonic, piezoelectric, or microelectromechanical system (MEMS), or fingerprint detection sensing array, and may comprise a plurality of sensing units P arranged in rows and columns, but it is not limited thereto. The panel 10 could be at least one of an organic light emitting diode (OLED) panel, an in-organic light emitting diode (OLED) panel(e.g., a mini light emitting diode (mini-LED) panel or a micro light emitting diode (micro-LED) panel), a quantum light emitting diode (QLED) panel, or a liquid crystal display (LCD) panel, but it is not limited thereto. In some embodiments, a plurality of panels 10 may be used to form a tiled panel. The column driver 104 comprises a multiplexer 1040 electrically connected to the sensing array 100.

The controlling circuit 14 comprises an analog-to-digital converter (ADC) 140 and a controller 142. The ADC 140 may be electrically connected to the multiplexer 1040 via the FPC 12, and is also electrically connected to the controller 142. The sensing array 100 may be electrically connected to the multiplexer 1040 to output electrical signals representing the fingerprint to the ADC 140, and in turn, the ADC 140 may convert the electrical signals from analog to digital to output biometric data to the controller 142, and the controller 142 may decide fingerprint information, such as fingerprint outline, according to the biometric data. The controller 142 maybe a microcontroller, a microprocessor, a processor or a field programmable gate array (FPGA), but it is not limited thereto.

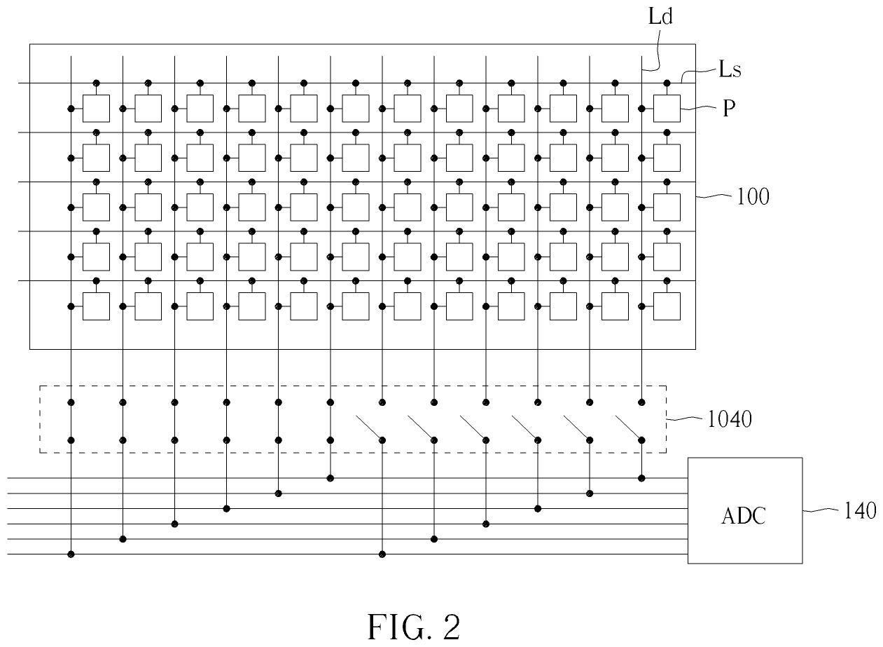

Referring now to FIG. 2, a schematic diagram of a selected portion of circuits in FIG. 1 is shown. The selected portion of circuits comprises the sensing array 100, the multiplexer 1040 and the ADC 140. The sensing array 100 comprises rows and columns of sensing units P arranged in a matrix or in a stagger (not shown in FIG. 2), but it is not limited thereto, and some parts of the sensing units P may be in an on-state to detect a fingerprint, and the other parts of the sensing units P may be in an off-state to disable detection of fingerprint in a scan process. In some embodiments, a profile of the sensing array 100 could be in a rectangular shape, a circle shape or a free shape, but it is not limited thereto. Sensing units in each row are electrically connected to a scan line Ls, and sensing units in each column are electrically connected to a data line Ld. During a scan process, the sensing array 100 may scan a fingerprint on a row-by-row basis, and for each given row, the sensing array 100 may scan across columns on the given row to output electrical signals representing a portion of the fingerprint. Specifically, the multiplexer 1040 may switch sequentially between groups of columns to transmit the electrical signals from the sensing array 100 to the ADC 140, where the electrical signals are sequentially converted into biometric data of the portion of the fingerprint.

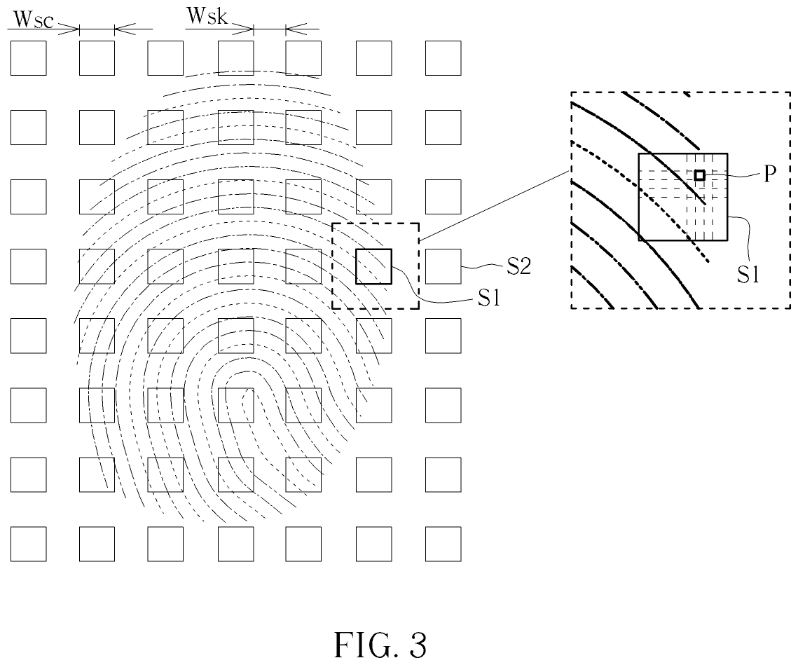

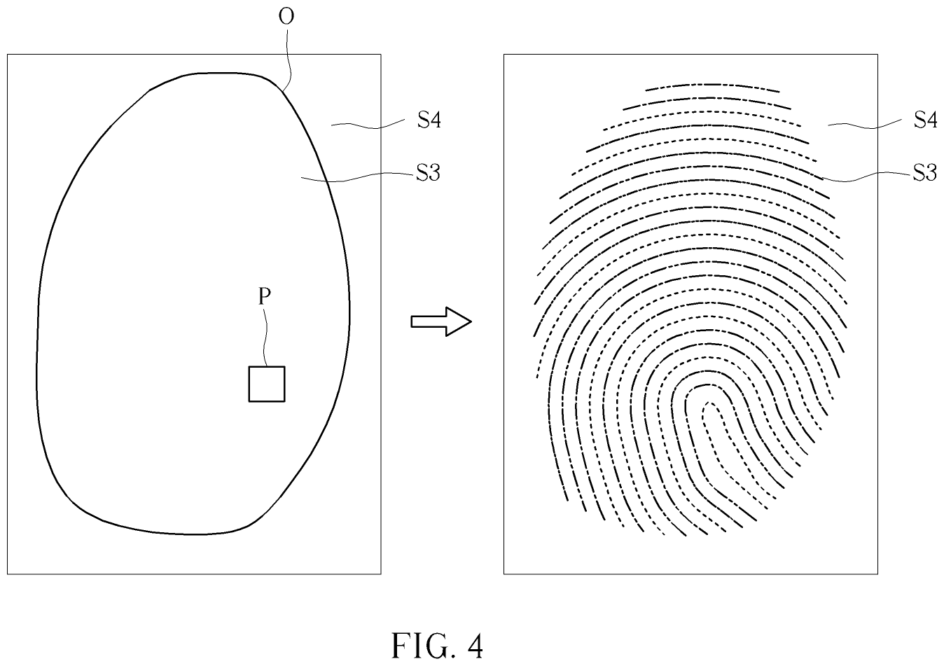

FIG. 3 shows a schematic diagram of a coarse scan employed in the biometric device 1 in FIG. 1. During a coarse scan, the biometric device 1 may scan the detection area at regular intervals, irregular intervals, or combination thereof to detect a fingerprint outline. The regular or irregular intervals may be configured along a horizontal axis of the detection area, a vertical axis of the detection area, or a combination thereof. The sensing units P of the sensing array 100 are configured into a plurality of scan areas and a plurality of skip areas arranged at intervals in the detection area of the sensing array 100. The coarse scan may be performed by enabling the plurality of scan areas and disabling the plurality of skip areas to detect the fingerprint outline. Some parts of the sensing units P are configured into the scan areas and are set to the on-state to detect a fingerprint, and the other parts of the sensing units P are configured into the skip areas and are set to the off-state. At least one of the plurality of skip areas has a skip width Wsk and at least one of the plurality of scan areas has a scan width Wsc, with the skip width Wsk being less than or equal to 10 mm and the scan width Wsc being more than or equal to 0.2 mm. The scan areas are enabled to detect fingerprints, and are represented by bold squares, with the bold squares representing a fingerprint or a fingerprint outline being detected. The skip areas are represented by blank area between the bold squares, and are disabled from detecting the fingerprint or the fingerprint outline. The fingerprint outline encloses a plurality of ridges and valleys, and one of some of the scan areas is configured to cover at least one portion of ridges and valleys. In some embodiments, at least one of the scan areas could be in a rectangular shape, a square shape, or a free shape for detecting a clearer fingerprint outline, but it is not limited thereto. For example, the scan area S1 has an area of 0.5 mm×0.5 mm and covers at least one ridge (shaded line portion) and at least one valley (blank line portion) , and each sensing unit P configured into the scan area S1 has a pixel area of 50 um×50 um. For a first scan area and a second area adjacent to each other in the plurality of scan areas, upon detecting a fingerprint in the first scan area and no fingerprint in the second scan area, the biometric device 1 may decide that the fingerprint outline O (please refer to the FIG. 4) is located between the first scan area and the second scan area thereof. For example, in FIG. 3, a fingerprint is detected in a first scan area S1 and no fingerprint is detected in a second scan area S2, and thus the biometric device 1 may decide that a fingerprint outline is located between the first scan area S1 and the second scan area S2. Since not all the detection area is scanned, the biometric device 1 can reduce signal processing time in the coarse scan.

FIG. 4 shows a schematic diagram of a fine scan employing the biometric device 1 in FIG. 1. During a fine scan, the biometric device 1 may scan an area S3 inside a fingerprint outline O to generate a fingerprint image. For example, the fine scan may be performed by enabling a part of the plurality of scan areas inside the fingerprint outline to generate the fingerprint image. During the duration of enabling the part of the plurality of scan areas inside the fingerprint outline, the other parts of the sensing units P configured into the skip areas are in on-state. Since the fingerprint outline O has been defined in the coarse scan as explained in FIG. 3, the biometric device 1 does not need to scan the area S4 outside the fingerprint outline O, and may scan only the area S3 inside the fingerprint outline O for a fingerprint image, and therefore, the biometric device 1 will reduce data processing time while not losing fingerprint image. In some embodiments, during the coarse scan, certain areas inside the fingerprint outline O have already been scanned, therefore, during the duration of the fine scan, the biometric device 1 may only scan the remaining areas inside the fingerprint outline O, and the remaining areas has not yet been scanned during the coarse scan, and the biometric device 1 may generate the fingerprint image by combining biometric data generated in the coarse scan and fine scan, so that it can further reduce signal processing time.

In some embodiments, the biometric device 1 may perform iterative coarse scans, iterative fine scans, or a combination thereof. For the iterative coarse scan, the biometric device 1 may first perform an initial coarse scan, and if the initial coarse scan fails to produce a clear fingerprint outline O, adjust an interval between two adjacent scan areas to configure a plurality of new scan areas and a plurality of new skip areas, then perform a subsequent coarse scan by enabling the plurality of new scan areas and disabling the plurality of new skip areas to detect and update fingerprint outline O, and continue the loop until a clear fingerprint outline O is detected. In one embodiment, the interval between two adjacent scan areas may be reduced in the subsequent coarse scan to increase coverage of fingerprint scanning, thereby detecting a clear fingerprint outline O. As a result, the iterative coarse scan can be used to enhance accuracy of fingerprint outline O determination through iterations. For the iterative fine scan, the biometric device 1 may first perform an initial fine scan, start another fine scan if the initial fine scan fails to generate a clear fingerprint image, and continue the loop until a clear fingerprint image is generated, thereby increasing a success rate of generating a clear fingerprint image.

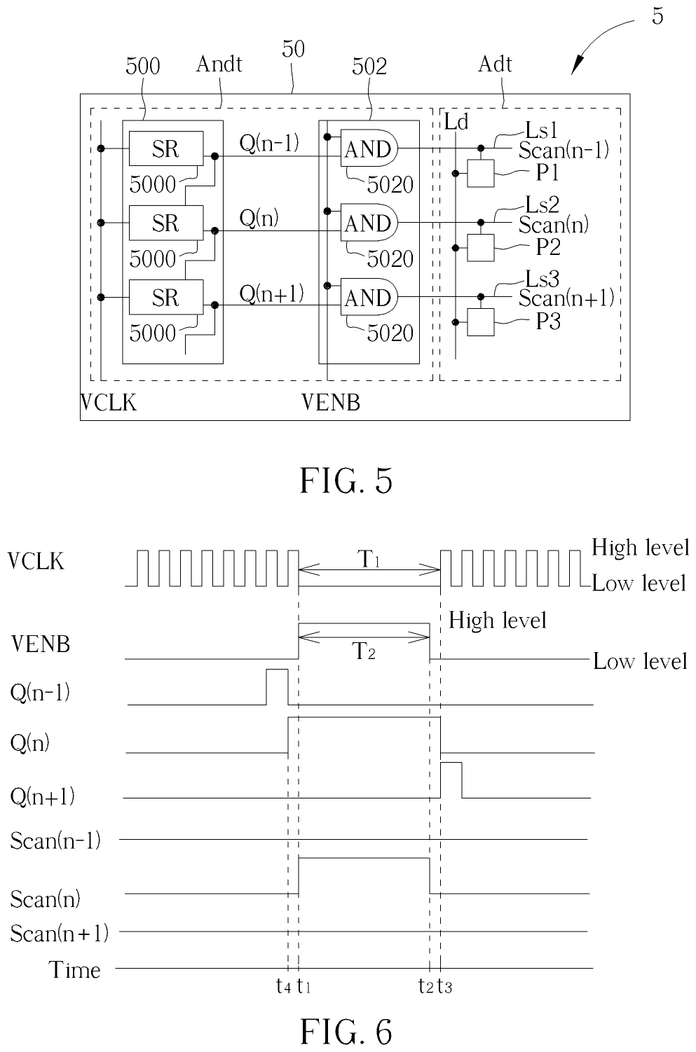

FIG. 5 is a circuit schematic of a biometric device 5 according to one embodiment of the invention. The biometric device 5 comprises a panel 50 comprising a driver circuit 500, a logic circuit 502, a plurality of signal lines Ls1, Ls2, Ls3, and a plurality of sensing units P1, P2, P3. The signal lines Ls1, Ls2, Ls3 may be scan lines in a sensing array, and respectively carry control signals Scan(n−1), Scan(n), Scan(n+1). The driver circuit 500 and the logic circuit 502 may form a row driver as discussed in FIG. 1. The driver circuit 500 is electrically connected to the logic circuit 502, and in turn, the logic circuit 502 is electrically connected to the plurality of sensing units P1, P2, P3. The driver circuit 500 comprises a plurality of shift registers 5000 respectively and electrically connected to the logic circuit 502. The logic circuit 502 comprises a plurality of AND logic gates 5020 electrically connected to the plurality of sensing units P1, P2, P3. In some embodiments, the logic circuit 502 may use other type of logic gate following a designer's real requirement, such as NAND gate, XOR gate, NOR gate, or combination thereto, but it is not limited thereto. The plurality of sensing units P1, P2, P3 are arranged along a data line extending direction or a vertical direction, but not limited thereto. Each of the sensing units P1, P2, P3 is respectively electrically connected to the logic circuit 502 via a corresponding signal line of the plurality of signal lines Ls1, Ls2, Ls3. Specifically, the signal line Ls1 corresponds to the sensing unit P1, the signal line Ls2 corresponds to the sensing unit P2, and the signal line Ls3 corresponds to the sensing unit P3.

The driver circuit 500 may generate driving signals Q(n−1), Q(n), Q(n+1) according to a clock signal VCLK. The logic circuit 502 may generate a plurality of control signals Scan(n−1), Scan(n), Scan(n+1) according to the driving signals Q(n−1), Q(n), Q(n+1) and an enable signal VENB, and the plurality of control signals Scan(n−1), Scan(n), Scan(n+1) are used to configure the plurality of sensing units P1, P2, P3 into at least one skip area, at least one scan area or combination thereof. In particular, when both the enable signal VENB and a driving signal are set active, a corresponding control signal is set active to further configure a sensing unit into a scan area, whereas when either the enable signal VENB or a driving signal is set inactive, a corresponding control signal is set inactive to further configure a sensing unit into a skip area.

Turning now to FIG. 6, a timing diagram illustrating detailed operations of circuit schematic of the biometric device 5 is shown. Explanation for the timing diagram in FIG. 6 is provided in relation to the components of circuit schematic of the biometric device 5 as shown in FIG. 5. The timing diagram includes the clock signal VCLK, the enable signal VENB, the driving signals Q(n−1), Q(n), Q(n+1), the control signals Scan(n−1), Scan(n), Scan(n+1), and a time axis. The clock signal VCLK may carry a minimum clock pulse to stop a corresponding sensing unit from scanning a fingerprint, and may be held “LOW” level for a predetermined period of time to enable the corresponding sensing unit to scan a fingerprint. The enable signal VENB maybe held “HIGH” level when the clock signal VCLK is held “LOW” level for the predetermined period of time, and is held “LOW” level when the clock signal carries the minimum clock pulse. The driving signals Q(n−1), Q(n), Q(n+1) are identical to each other except for the pulse widths. The control signals Scan(n−1), Scan(n), Scan(n+1) may be set as active to enable a corresponding sensing unit to scan a fingerprint, and set as inactive to stop the corresponding sensing unit from scanning a fingerprint.

FIG. 6 depicts an example of setting the control signal Scan (n) as active and setting the control signals Scan(n−1), Scan(n+1) as inactive, and the control signals Scan(n−1), Scan(n), Scan(n+1) may configure the sensing unit P2 into a scan area and configure the sensing units P1, P3 into skip areas respectively. The clock signal VCLK is held “LOW” level starting from Time t1, continuing for a period T1 and finishing at Time t3. In turn, the clock signal VCLK sets the enable signal VENB to “HIGH” level starting from Time t1, continuing for a period T2 and finishing at Time t2, and the clock signal VCLK extends a pulse width of the driving signal Q(n) from Time t4 to Time t3. Accordingly, the logic circuit 502 mostly generates an active control signal when both the enable signal VENB and a corresponding driving signal are active, and thus, the control signals Scan(n−1), Scan(n+1) are set as inactive while the control signal Scan(n) is set as active, thereby configuring the sensing unit P2 into a scan area and configuring the sensing units P1, P3 into skip areas.

Returning to FIG. 5, the panel 50 has a detection area Adt and a non-detection area Andt located adjacent to the detection area Adt. The detection area Adt is an area on the panel 50 where a fingerprint can be detected, and the non-detection area Andt is another area on the panel 50 where no fingerprint can be detected. At least a part of the driver circuit 500 is located in the non-detection area Andt. FIG. 5 exemplifies a possible circuit placement in which the complete driver circuit 500 and the logic circuit 502 are located in the non-detection area Andt, and at least one part of the plurality of signal lines Ls1, Ls2, Ls3, and the plurality of sensing units P1, P2, P3 are located in the detection area Adt, it should be understood that other circuit placements are also possible.

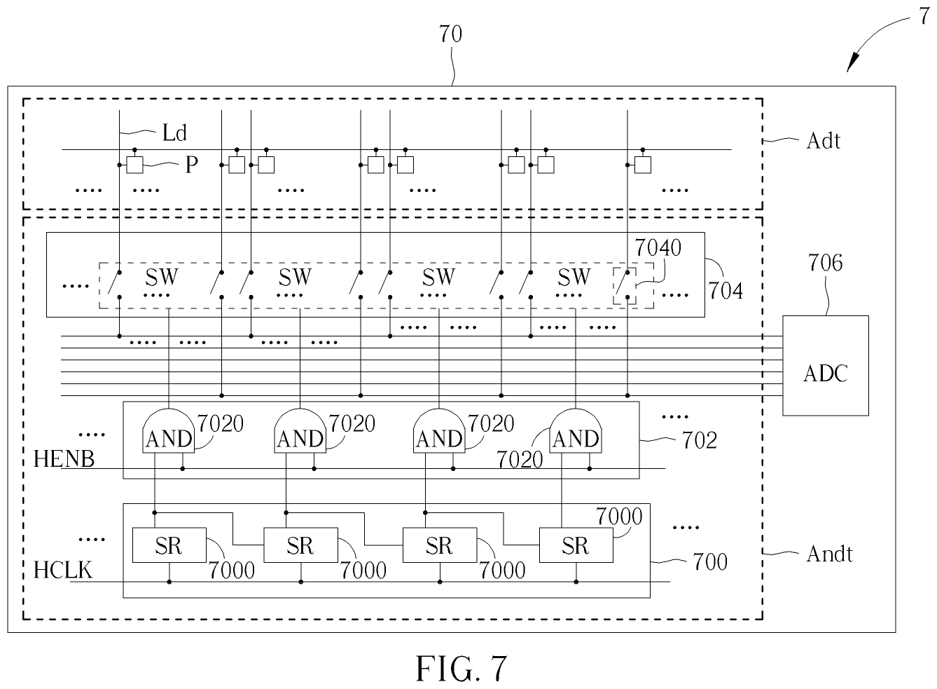

FIG. 7 is a circuit schematic of a biometric device 7 according to another embodiment of the invention. The biometric device 7 comprises a panel 70 comprising a driver circuit 700, a logic circuit 702, a multiplexer 704, an ADC 706, a plurality of signal lines Ld, and a plurality of sensing units P. The signal lines Ld may be data lines in a sensing array, and respectively carry corresponding sensing units with date signal. The driver circuit 700, the logic circuit 702 and the multiplexer 704 may form a column driver 104 as discussed in FIG. 1. The driver circuit 700 is sequentially electrically connected to the logic circuit 702, the multiplexer 704, and then to the plurality of sensing units P. The ADC 706 is electrically connected to the multiplexer 704. The driver circuit 700 comprises a plurality of shift registers 7000 respectively and electrically connected to the logic circuit 702. The logic circuit 702 comprises a plurality of AND logic gates 7020 electrically connected to the multiplexer 704. The multiplexer 704 comprises a plurality of switch circuits 7040 located between the logic circuit 702 and the plurality of sensing units P and electrically connected to the ADC 706. The plurality of sensing units P are arranged along a scan line extending direction or a horizontal direction, but not limited thereto. Each of the sensing units P is electrically connected to the logic circuit 702 via a corresponding signal line Ld.

The plurality of switch circuits 7040 may be selected sequentially to select a predefined group of the sensing units P and couple the predefined group of the sensing units P to the ADC 706, and the ADC 706 may convert electrical signals generated by the electrically connected sensing units P into biometric data. The circuit configuration and connection of the driver circuit 700 and the logic circuit 702 are identical to those in FIG. 5, and thus the explanation therefor is omitted for brevity.

The panel 70 has a detection area Adt and a non-detection area Andt located adjacent to the detection area Adt. The detection area Adt is an area on the panel 70 where a fingerprint can be detected, and the non-detection area Andt is another area on the panel 70 where no fingerprint can be detected. At least a part of the driver circuit 700 is located in the non-detection area Andt. FIG. 7 exemplifies a possible circuit placement in which the complete driver circuit 700, the logic circuit 702, the multiplexer 704, and the ADC 706 are located in the non-detection area Andt, and, at least one part of the plurality of signal lines Ld, and the plurality of sensing units P are located in the detection area Adt, it should be understood that other circuit placements are also possible.

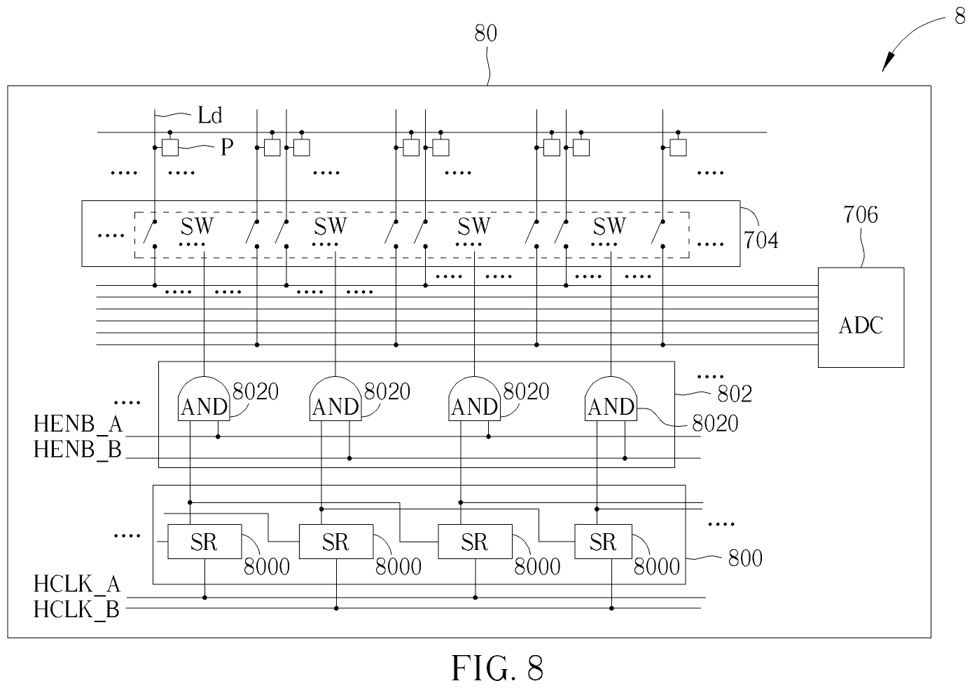

FIG. 8 is a circuit schematic of a biometric device 8 according to yet another embodiment of the invention. The biometric device 8 comprises a panel 80 comprising a driver circuit 800, a logic circuit 802, a multiplexer 704, an ADC 706, a plurality of signal lines Ld, and a plurality of sensing units P. The signal lines Ld may be data lines in a sensing array, and respectively carry corresponding sensing units with data signal. The driver circuit 800, the logic circuit 802 and the multiplexer 704 may form a column driver 104 as discussed in FIG. 1. The driver circuit 800 is sequentially electrically connected to the logic circuit 802, the multiplexer 704, and then to the plurality of sensing units P. The ADC 706 is electrically connected to the multiplexer 704. The circuit configuration and connection of the multiplexer 704, the ADC 706, the plurality of signal lines Ld and the sensing array containing the plurality of sensing units P are identical to those in FIG. 7, and thus the explanation therefor is omitted for brevity.

The discussion will be directed towards the driver circuit 800 and the logic circuit 802, as the driver circuit 800 and the logic circuit 802 are configured and operated differently from the driver circuit 700 and the logic circuit 702 in FIG. 7. The driver circuit 800 contains 2-phased shift registers 8000, wherein the shift registers 8000 are grouped into a first group_HCLK_A and a second group_HCLK_B, and the first group_HCLK_A and the second group_HCLK_B are separately fed with clocks of different phases. The logic circuit 802 contains 2-phased AND logic gates 8020, wherein the AND logic gates 8020 are grouped into a first group_HENB_A and a second group_HENB_B. The first group of the shift registers 8000 are connected in cascade and configured to receive a first clock HCLK_A to generate first driving signals. The second group of the shift registers 8000 are connected in cascade and configured to receive a second clock HCLK_B to generate second driving signals. In one embodiment, the first clock HCLK_A and the second clock HCLK_B are in different phase, such as antiphase, but it is not limited thereto. In some embodiments, the antiphase may be a difference of a maximum value of the first clock HCLK_A and a minimum value of the second clock HCLK_B within a range of 180±10 degrees in time or phase axis, but it is not limited thereto. Members of the first group of the shift registers 8000 are connected to respective members of the first group of AND logic gates 8020; and members of the second group of the shift registers 8000 are connected to respective members of the second group of AND logic gates 8020. The first group of AND logic gates 8020 are configured to receive a first enabling signal HENB_A and the first driving signals to generate first control signals; and the second group of AND logic gates 8020 are configured to receive a second enabling signal HENB_B and the second driving signals to generate second control signals. Since the driver circuit 800 and the logic circuit 802 are operated by clocks having different phases, the speed of the horizontal scan can be increased by 2.

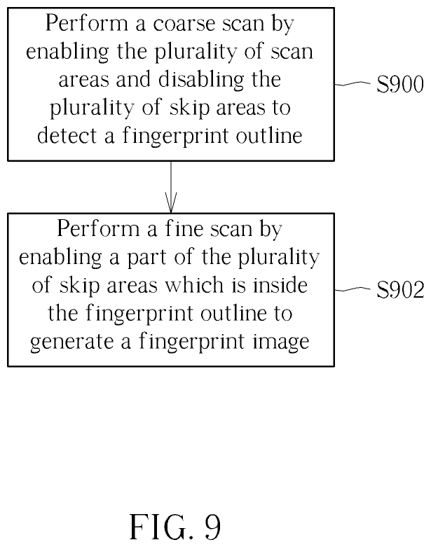

FIG. 9 is a flowchart of a fingerprint scanning method employing the biometric device in FIG. 1, FIG. 5, FIG. 7, or FIG. 8. For simplicity, Steps of the fingerprint scanning method are provided with respect to the biometric device 1 in FIG. 1. The fingerprint scanning method in FIG. 9 discloses a 2-step scan process, and comprises Steps S900 and S902. Any reasonable technological change or Step adjustment is within the scope of the present application. Steps S900 and S902 are detailed as below:

S900: Perform a coarse scan by enabling the plurality of scan areas and disabling the plurality of skip areas to detect a fingerprint outline;

S902: Perform a fine scan by enabling a part of the plurality of skip areas which is inside the fingerprint outline to generate a fingerprint image.

Details of Steps S900 and S902 are provided in the preceding paragraphs, and explanation therefor is omitted for brevity.

The biometric devices in FIGS. 1, 5, 7, 8 incorporate row drivers and column drivers into touchscreen panels, simplifying manufacturing process while reducing manufacturing costs. Further, the biometric devices and the biometric scanning method in FIGS. 1, 5, 7, 8, 9 adopt a 2-step scan process, capable of speeding up signal processing while further manufacturing costs.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A biometric device comprising:
a panel, comprising a detection area and a non-detection area adjacent to the detection area, and comprising:
a driver circuit, at least a part of the driver circuit being located in the non-detection area;
a first logic circuit, electrically connected to the driver circuit, and configured to generate a plurality of control signals;
a plurality of signal lines, at least a part of the plurality of signal lines being located in the detection area; and
a plurality of sensing units, located in the detection area and arranged along one direction, each respectively and electrically connected to the first logic circuit and a corresponding signal line in the plurality of signal lines,
wherein when each sensing unit in the plurality of sensing units receives one of the plurality of control signals, the plurality of sensing units are configured into a plurality of skip areas and a plurality of scan areas; and
the plurality of skip areas are disabled in a coarse scan process and the plurality of scan areas are enabled to detect the fingerprint outline in the coarse scan process.

2. The biometric device of claim 1, wherein in a fine scan process, the plurality of skip areas inside the fingerprint outline are scanned to generate a fingerprint image.

3. The biometric device of claim 1, wherein at least one of the plurality of skip areas has a skip width Wsk along the one direction, at least one of the plurality of scan areas has a scan width Wsc along the one direction, the skip width is less than or equal to 10 mm and the scan width is more than or equal to 0.2 mm.

4. The biometric device of claim 1, wherein the panel further comprises a controller electrically connected to at least one of the plurality of signal lines, and configured to decide the fingerprint outline according to the plurality of scan areas.

5. The biometric device of claim 1, wherein the plurality of scan areas covers at least one portion of the fingerprint outline.

6. The biometric device of claim 1, wherein the first logic circuit is located between the driver circuit and the plurality of sensing units.

7. The biometric device of claim 1, wherein the driver circuit comprises a plurality of shift registers respectively and electrically connected to the first logic circuit.

8. The biometric device of claim 1, wherein:
the panel further comprises a second logic circuit located in the non-detection area, the second logic circuit comprises a first group of AND logic gates and a second group of AND logic gates, and the first group of AND logic gates and the second group of AND logic gates are alternately arranged and electrically connected to the plurality of sensing units.

9. The biometric device of claim 8, wherein:
the panel further comprises a plurality of shift registers 800 respectively grouped into a first group and a second group;
the first group of the shift registers are electrically connected in cascade and configured to receive a first clock to generate first driving signals;
the second group of the shift registers are electrically connected in cascade and configured to receive a second clock to generate second driving signals;
members of the first group of the shift registers are electrically connected to respective members of the first group of AND logic gates;
members of the second group of the shift registers are electrically connected to respective members of the second group of AND logic gates;
the first group of AND logic gates are configured to receive a first enabling signal and the first driving signals to generate first control signals; and
the second group of AND logic gates are configured to receive a second enabling signal and the second driving signals to generate second control signals.

10. The biometric device of claim 9, wherein the first clock and the second clock are of different phases.

11. The biometric device of claim 1, wherein the first logic circuit comprises a plurality of AND logic gates, at least one of the plurality of AND logic gates is electrically connected to the plurality of sensing units.

12. The biometric device of claim 1, wherein the panel further comprises:
a plurality of switch circuits configured to be selected sequentially to electrically connect a predefined group of the sensing units.

13. The biometric device of claim 12, wherein the panel further comprises:
an analog-to-digital converter electrically connected to the plurality of switch circuits, and configured to convert electrical signals generated by the selected sensing units into biometric data.

14. A biometric scanning method performed by a biometric device, the biometric device comprising a detection area, the detection area including a plurality of skip areas and a plurality of scan areas, and the biometric scanning method comprising:
performing a coarse scan by enabling the plurality of scan areas and disabling the plurality of skip areas to detect a fingerprint outline; and
performing a fine scan by enabling a part of the plurality of skip areas which is inside the fingerprint outline to generate a fingerprint image.

15. The biometric scanning method of claim 14, wherein the fingerprint outline encloses a plurality of ridges and valleys, and the plurality of scan areas covers at least one portion of the fingerprint outline.

16. The biometric scanning method of claim 14, wherein the step of performing the coarse scan further comprises:
detecting the fingerprint in a first scan area of the plurality of scan areas and no fingerprint in a second scan area of the plurality of scan areas, wherein the second scan area is adjacent to the first scan area,
deciding that the fingerprint outline is located between the first scan area and the second scan area.

17. The biometric scanning method of claim 14, wherein after the step of performing the coarse scan and before the step of performing the fine scan, the biometric scanning method further comprises:
adjusting an interval between two adjacent scan areas to configure a plurality of new scan areas and a plurality of new skip areas; and
performing a subsequent coarse scan by enabling the plurality of new scan areas and disabling the plurality of new skip areas to detect the fingerprint outline.

18. The biometric scanning method of claim 17, wherein the interval between two adjacent scan areas is configured along a horizontal axis of one of the two adjacent scan areas, a vertical axis of the one of the two adjacent scan areas, or a combination thereof.

19. The biometric scanning method of claim 17, wherein the step of adjusting the interval between two adjacent scan areas further comprises:
reducing the interval to configure the plurality of new scan areas and the plurality of new skip areas.

20. The biometric scanning method of claim 14, wherein after the step of performing the fine scan, the biometric scanning method further comprises:
generating the fingerprint image according to a combination data of the coarse scan and fine scan.
